(19) United States
(12) Patent Application Publication
(10) Pub. No.: US 2018/0104991 A1
(43) Pub. Date: Apr. 19, 2018

(54) PNEUMATIC TIRE

(71) Applicant: HANKOOK TIRE CO., LTD., Seoul (KR)

(72) Inventor: Ji Hun Park, Daejeon (KR)

(21) Appl. No.: 15/786,496

(22) Filed: Oct. 17, 2017

(30) Foreign Application Priority Data
Oct. 17, 2016 (KR) 10-2016-0134640

(51) Int. Cl. B60C 11/03; B60C 11/01

(52) U.S. Cl. CPC B60C 11/0309; B60C 11/01

(57) ABSTRACT

The disclosed technology relates tires and particularly to a pneumatic tire with improved wear resistance. The pneumatic tire includes a tread, sidewalls and a bead portion. The tread includes a top surface on which a plurality of blocks and grooves are formed. The pneumatic tire additionally includes a plurality of ground contact pressure-reducing blocks that are mounted in the grooves that adjoin the blocks along a direction of travel and adjacent to forward directional trailing portions of the blocks.

### CROSS-REFERENCE TO RELATED APPLICATIONS

This application claims foreign priority to Korean Patent Application No. 10-2016-0134640, filed Oct. 17, 2016, the content of which is incorporated by reference herein in its entirety.

### BACKGROUND

### Field

The disclosed technology relates tires and particularly to a pneumatic tire with improved wear resistance.

### Description of the Related Technology

In pneumatic tires, e.g., truck and bus radial (TBR) tires, a type of uneven wear on tread blocks known as heel and toe wear, occurs frequently. Heel and toe wear occurs when a part of a block that touches down first wears more slowly than a part that touches down later. The leading portion of the block, which wears at a slower rate, is called a heel, and the trailing portion, which wears at a faster rate, is called a toe.

In order to reduce the aforementioned heel and toe wear, a structure for minimizing distortion of the heel part touching down first is employed. When driving a tire, force is exerted on the heel part in a direction opposite to which the car is traveling, and the rubber block is pushed back. Since rubber is incompressible, a lot of pressure is exerted on the toe part when the rubber block is pushed back, and this rapidly increase the slip velocity when the block slips away from the ground, thereby causing a lot of wear on the toe part. Accordingly, in order to minimize distortion of the heel part, the sides of grooves on the heel part are gently sloped, while the sides of the toe part are nearly vertical. However, it is difficult to reduce heel and toe wear by changing the angle of the sides of the grooves to reduce rubber distortion. This is due to an abrupt decrease in the force of friction on the toe part, which is caused by a rise in ground contact pressure on the toe part. Hence, there is a need for designs that increase the force of friction on the toe part.

Hereinafter, conventional technologies for improving the above-described uneven heel and toe wear problem will be described. Identification numbers used in the conventional technologies are irrelevant to the present application.

Korean Patent Utility Model Registration No. 0125391, titled “Tire with Improved Wear Resistance,” disclosed on Jun. 18, 1997, discloses a tire with improved wear resistance which can improve the wear resistance of a tread portion by forming grooves defining blocks on the tread portion and sipes on the blocks which slope at different angles on both sidewalls. Conventionally, the grooves 20 and the sipes 30 slope at the same angle on both sidewalls, so both sidewalls 22 and 24 of the grooves and both sidewalls 32 and 34 of the sipes do not wear at the same rate because of frequent braking and driving of the tire, but one sidewall, that is, the sidewall 24 and 34 positioned opposite to the direction of rotation of the tire, wears more quickly (heel and toe wear) than the sidewall 22 and 32 on the other side, thus shortening the overall lifespan of the tire. In view of this, the disclosure No. 0125391 is aimed at providing a tire with improved wear resistance which can extend the lifespan of the tire by allowing sidewalls forming grooves and sipes to wear at the same rate. Of the two sidewalls 22 and 24 of the grooves 20, the sloping angle θb of the sidewall 24 aligned to the direction of rotation of the tire is obtuse and the sloping angle θa of the opposite sidewall 22 is acute. Likewise, of the two sidewalls 32 and 34 of the sipes 30, the sloping angle θd of the sidewall 34 aligned to the direction of rotation of the tire is obtuse and the sloping angle θc of the opposite sidewall 32 is acute. In the disclosure No. 0125391, as described above, the sides of grooves on the heel part are gently sloped, while the sides of the toe part are nearly vertical. As previously mentioned, there may be an abrupt decrease in the force of friction on the toe part, which is caused by a rise in ground contact pressure on the toe part, thus making it difficult to reduce heel and toe wear.

Korean Patent Registration No. 10-0782462, titled “Kerf Structure for Tread Blocks with Improved Block Wear Resistance,” disclosed on Jan. 12, 2006, relates to a kerf structure for tread blocks with improved block wear resistance which minimizes changes in the tire's performance by reducing wear on the tire's tread blocks, and prevents heel and toe wear by alleviating impact on the block. In a tire tread's block pattern structure comprising a center block group 1 having radially zigzag kerfs K1 formed with respect to the centerline CL of the circumference of the tire, a middle block group 4 having radially zigzag kerfs K2 formed with the center block group 1 and circumferential grooves 2 and 3 in between, and a peripheral block group 5, a plurality of radially linear kerfs K3 and circumferential zigzag kerfs K4 on the tire intersecting each other are formed on individual blocks 5a of the peripheral block group 5, and the circumferential zigzag kerfs K4, starting ahead of the direction of travel of the tire, are spaced a width W2 apart from the end portion of the blocks 5a. Although the disclosure No. 10-0782462 attempted to overcome heel and toe wear through the kerfs on the blocks, it was difficult to expect good results because the narrow and deep kerfs cause a decline in the overall stiffness of the blocks and are filled with foreign materials while driving.

FIG. 1 is an example illustration of heel and toe wear. Referring to FIG. 1, as described above, the sides of grooves on the heel part are gently sloped, while the sides of the toe part are nearly vertical, in order to minimize distortion of the heel part. However, as previously mentioned, it is difficult to reduce heel and toe wear by changing the angle of the sides of the grooves to reduce rubber distortion. This is due to an abrupt decrease in the force of friction on the toe part, which is caused by a rise in ground contact pressure on the toe part. Hence, there is a need for designs that increase the force of friction on the toe part.

### SUMMARY OF CERTAIN INVENTIVE ASPECTS

A technical aspect of the disclosed technology is directed to providing a pneumatic tire which can effectively improve heel and toe wear without deteriorating the stiffness of tread blocks.

Technical aspects to be achieved by the disclosed technology are not limited to the aforementioned technical aspect, and other technical aspects not mentioned above will be clearly understood by those skilled in the art from the following descriptions.

An exemplary embodiment of the disclosed technology provides a pneumatic tire including a tread, sidewalls, and a bead portion, with blocks and grooves formed in the top surface of the tread, in which ground contact pressure reducing blocks are mounted in the grooves along the direction of travel that adjoin the blocks, adjacent to forward directional trailing portions of the blocks.

In an exemplary embodiment of the disclosed technology, connecting ribs may be mounted to connect the ground contact pressure reducing blocks.

In an exemplary embodiment of the disclosed technology, the direction-of-travel width of the ground contact pressure reducing blocks may be 5 to 20% of the direction-of-travel length of the blocks.

In an exemplary embodiment of the disclosed technology, the transverse width of the ground contact pressure reducing blocks may be 70 to 90% of the width of the grooves in which the ground contact pressure blocks are mounted.

In an exemplary embodiment of the disclosed technology, the height of the ground contact pressure reducing blocks may be equal to the depth of the grooves in which the ground contact pressure blocks are mounted.

In an exemplary embodiment of the disclosed technology, the height of the connecting ribs may be 10 to 50% of the depth d of the grooves.

In an exemplary embodiment of the disclosed technology, the width of the connecting ribs may be 10 to 30% of the width of the grooves to which the connecting ribs are mounted.

In an exemplary embodiment of the disclosed technology, one end of the ground contact pressure reducing blocks along the transverse direction may adjoin the blocks.

According to the exemplary embodiment of the disclosed technology, ground contact pressure can be instantaneously reduced by maintaining uniform distribution of ground contact pressure along the groove edges by increasing the ground contact area of the trailing portions of the tread blocks, thereby suppressing heel and toe wear.

The effects of the present invention are not limited to the above, but they should be construed as encompassing all the effects that can be inferred from a detailed description of the present invention or a construction of the invention set forth in the claims.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is an example illustration of heel and toe wear in tires;

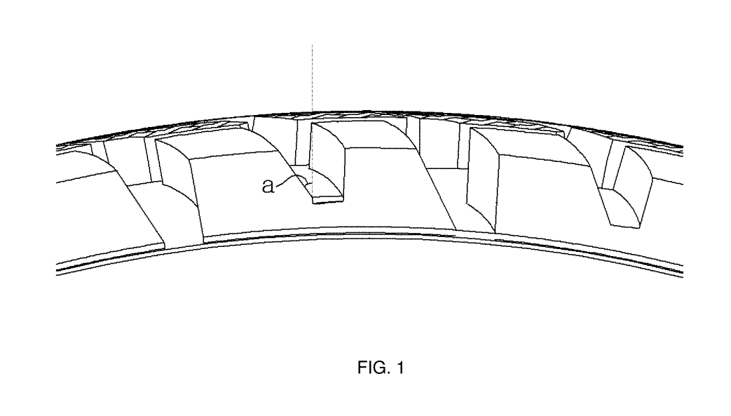

FIG. 2 is a perspective view showing different parts of a pneumatic tire, according to the disclosed technology;

FIG. 3 is a graph illustrating the relationship between ground contact pressure and friction coefficient; and

FIG. 4 is a perspective view illustrating parts of a pneumatic tire, according to another exemplary embodiment of the disclosed technology.

### DETAILED DESCRIPTION OF CERTAIN ILLUSTRATIVE EMBODIMENTS

Hereinafter, the present invention will be described with reference to the accompanying drawings. The exemplary embodiments may, however, be embodied in many different forms and should not be construed as limited to the exemplary embodiments set forth herein. In the drawings, parts irrelevant to the descriptions are omitted for clarity, and like reference numerals refer to like parts throughout the specification.

Throughout the specification, reference to a certain portion being “connected” to another portion not only encompasses cases of being “directly connected” but also encompasses cases of being “indirectly connected” by way of another member positioned in-between. When a certain part is described as “including” another component, this means that the part can further include other components and is not meant to exclude other components unless explicitly mentioned otherwise.

The terms used in the specification are intended to describe particular embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, an exemplary embodiment of the present invention will be described in detail with reference to the accompanying drawings. The disclosed technology generally relates tires and particularly to a pneumatic tire with improved wear resistance, and more particularly to a pneumatic tire which improves uneven heel and toe wear on tread blocks of truck and bus radial (TBR) tires.

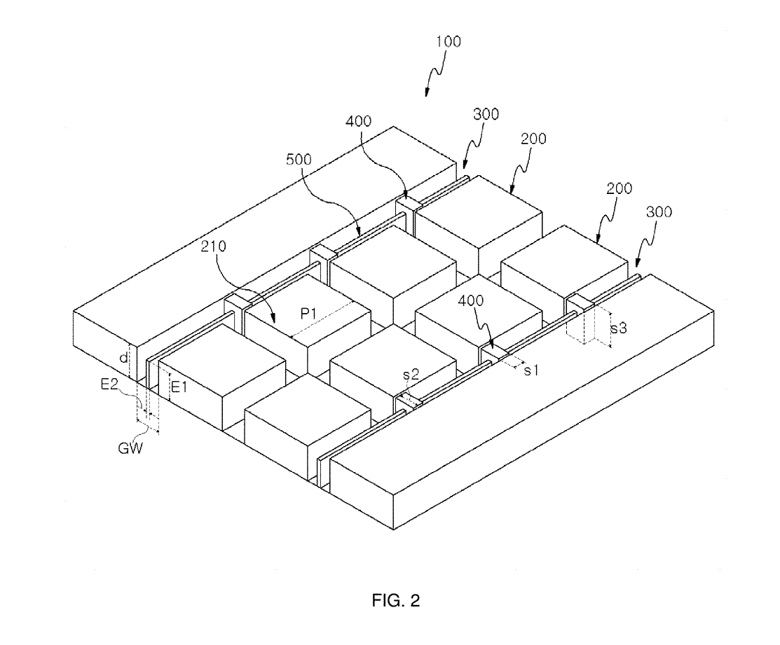

FIG. 2 is a perspective view showing the main parts of a pneumatic tire according to the present invention.

As shown in FIG. 2, the disclosed technology provides a pneumatic tire including a tread 100, sidewalls (not shown) and a bead portion (not shown), where the tread 100 has formed on a top surface of the tread 100 a plurality of blocks 200 that are separated from each other by one or more of a plurality of grooves 300. The grooves have formed or mounted therein one or more ground contact pressure reducing blocks 400 along the direction of travel adjoining the blocks 200, and adjacent to forward directional trailing portions 210 of the blocks 200. As describe herein, a forward directional trailing portion 210 of a block 200 refers to a portion of the block 200 that contacts the ground at a relatively later time compared to a leading portion of the block 200 when the vehicle is moving in a forward direction.

As the ground contact pressure blocks 400 are mounted to the forward directional trailing portions 210 corresponding to the toe parts of the blocks 200, ground contact pressure can be instantaneously reduced by maintaining uniform distribution of ground contact pressure along the groove edges by increasing the ground contact area of the trailing portions of the tread blocks when coming into contact with the ground, thereby suppressing heel and toe wear. The increase in ground contact area leads to a decrease in ground contact pressure.

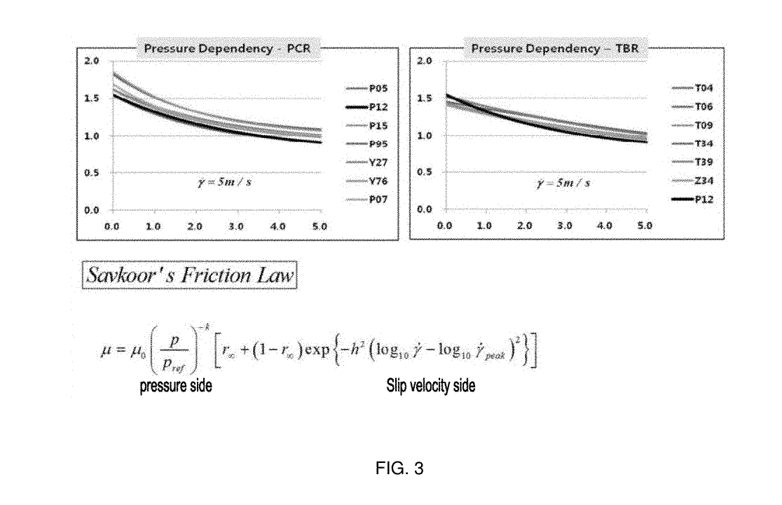

Referring to FIG. 3, the relationship between ground contact pressure and friction coefficient can conform to Savkoor's friction law, which corresponds to a graph in which the friction coefficient increases with decreasing pressure, thus reducing the amount of slip. The first graph of FIG. 3 shows measurements on passenger car radial (PCR) tires, and the second graph shows measurements on truck and bus radial (TBR) tires. From the measurements in both graphs, it can be seen that the friction coefficient decreases with increasing pressure according to Savkoor's friction law.

To effectively distribute ground contact pressure when the toe parts of the blocks 200 come into contact with the ground, the direction-of-travel width s1 of the ground contact pressure reduction blocks 400 may be 5 to 20% of the direction-of-travel length P1 of the blocks 200, a transverse width s2, which can be in a direction orthogonal to the direction-of-travel width s1, may be 70 to 90% of the width GW of the grooves 300 in which the ground contact pressure blocks 400 are mounted, and the height s3 of the ground contact pressure reducing blocks 400 may be about equal to the depth d of the grooves 300 in which the ground contact pressure blocks 400 are mounted. The inventors have found that these numerical values of the s1, s2 and s3 are effective values that allow for uniform distribution of ground contact pressure on the toe parts, minimize the constraints on the water drainage performance, among other performance metrics, of the grooves 300, and make the ground contact pressure reducing blocks 400 distinguishable from neighboring, plain blocks, e.g., blocks 200. Under some circumstances, the s1, s2 and s3 can be critical values that allow for uniform distribution of ground contact pressure on the toe parts, minimize the constraints on the water drainage performance, among other performance metrics, of the grooves 300, and make the ground contact pressure reducing blocks 400 distinguishable from neighboring, plain blocks, e.g., blocks 200.

The ground contact pressure reducing blocks 400 have the above dimensions so as not to impair the water drainage performance, etc. of the grooves 300. With these dimensions, however, the durability of the ground contact pressure reducing blocks 400 may be lowered. Accordingly, connecting ribs 500 may be mounted to connect the ground contact pressure reducing blocks 400. The height E1 of the connecting ribs 500 may be 10 to 50% of the depth d of the grooves 300, and the width E2 of the connecting ribs 500 may be 10 to 30% of the width GW of the grooves 300 to which the connecting ribs 500 are mounted.

The inventors have found that these numerical values of E1 and E2 are effective values that increase the durability of the individual ground contact pressure reducing blocks 400 and minimize the adverse effects on the water drainage performance, among other performance parameters, of the grooves 300. Under some circumstances, these numerical values of are E1 and E2 can be critical for increasing the durability of the individual ground contact pressure reducing blocks 400 and minimizing the adverse effects on the water drainage performance, among other performance parameters, of the grooves 300.

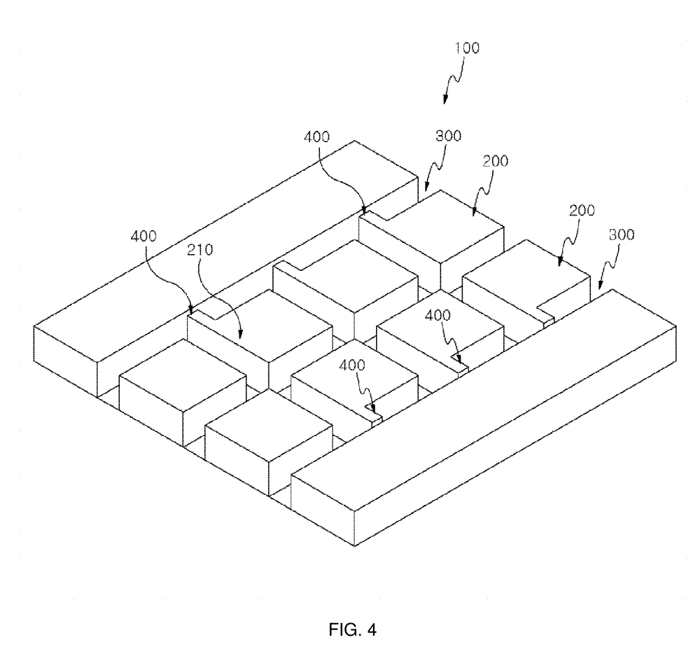

In another exemplary embodiment, the disclosed technology provides a pneumatic tire in which one end of the ground contact pressure reducing blocks 400 along the transverse direction adjoins the blocks 200, as shown in FIG. 4. As described above, with the above dimensions, the durability of the ground contact pressure reducing blocks 400 may be lowered. Therefore, this exemplary embodiment may use a configuration in which one end of the ground contact pressure reducing blocks 400 along the transverse direction adjoins the blocks 200, as a way to substitute for the connecting ribs 500 of FIG. 2. With this configuration, the durability of the ground contact pressure reducing blocks 400 may be greatly enhanced. Preferably, the ground contact pressure reducing blocks 400 according to this exemplary embodiment may have the dimensions given in the previous exemplary embodiment.

The aforementioned description is provided for purposes of illustration and description. It will be appreciated by those skilled in the art that various modifications may be readily made without departing from the technical spirit or essential features of the disclosure. Thus, the exemplary embodiments should be understood to be illustrative in every aspect and not to be limiting. For example, each constituent element described in a singular form may be distributed and thereby implemented. Likewise, constituent elements described to be distributed may be implemented in a combined form.

The scope of the disclosure is within the claims rather than the detailed description. Also, it is to be interpreted that the meanings and the scope of the claims and all the changes or modifications from the equivalents thereof are included in the scope of the disclosure.

What is claimed is:

1. A pneumatic tire comprising:
a tread, sidewalls, and a bead portion, wherein the tread comprises a top surface on which a plurality of blocks and grooves are formed, wherein a plurality of ground contact pressure-reducing blocks are mounted in the grooves that adjoin the blocks along a direction of travel and adjacent to forward directional trailing portions of the blocks.

2. The pneumatic tire of claim 1, further comprising connecting ribs mounted in the grooves that connect the ground contact pressure reducing blocks.

3. The pneumatic tire of claim 1, wherein a first width of the ground contact pressure reducing blocks in the direction of travel is 5 to 20% of a length of the blocks in the direction of travel.

4. The pneumatic tire of claim 1, wherein a transverse width of the ground contact pressure reducing blocks in a direction transverse to the direction of travel is 70 to 90% of the width of the grooves in which the ground contact pressure blocks are mounted.

5. The pneumatic tire of claim 1, wherein the height of the ground contact pressure reducing blocks is equal to the depth of the grooves in which the ground contact pressure blocks are mounted.

6. The pneumatic tire of claim 2, wherein the height of the connecting ribs is 10 to 50% of the depth d of the grooves.

7. The pneumatic tire of claim 2, wherein the width of the connecting ribs may be 10 to 30% of the width of the grooves to which the connecting ribs are mounted.

8. The pneumatic tire of claim 1, wherein one end of the ground contact pressure reducing blocks along the transverse direction adjoins the blocks.

9. A tread of a pneumatic tire for a vehicle, comprising:
a plurality of blocks that are separated from each other by one or more first grooves extending in a direction of travel and by one or more second grooves extending in a transverse direction orthogonal to the direction of travel,
wherein each block has a leading portion and a trailing portion, wherein the leading portion is configured to make contact with the ground prior to the trailing portion when the vehicle is moving; and
a plurality of pressure-reducing blocks formed in the at least one of the one or more first grooves adjacent the trailing portion of at least some of the blocks,
wherein each of the pressure-reducing blocks has a smaller lateral area compared to a lateral area of each of the blocks.

10. The tread of claim 9, wherein the blocks form a plurality of rows in the direction of travel, wherein at least one of the first grooves has the pressure-reducing blocks formed therein while at least one of the first grooves does not have the pressure-reducing blocks formed therein.

11. The tread of claim 10, wherein adjacent ones of the pressure reducing blocks in the direction of travel are interconnected by a rib extending in the direction of travel.

12. The tread of claim 10, wherein each of the pressure reducing blocks form are integrally connected to a respective one of the plurality of blocks.
